(19) United States
(12) Patent Application Publication
(10) Pub. No.: US 2025/0098690 A1
(43) Pub. Date: Mar. 27, 2025

(54) Heat Processor for Raw Poultry Products

(71) Applicant: Phoenix Innovations, Inc., Chancellor, AR (US)

(72) Inventors: Michael E. Miller, Hattieville, AR (US); Lucas M. Miller, London, AR (US); Nathan Harrison, Russellville, AR (US); Darin Chancellor, Russellville, AR (US)

(21) Appl. No.: 18/883,899

(22) Filed: Sep. 12, 2024

Related U.S. Application Data
(60) Provisional application No. 63/540,260, filed on Sep. 25, 2023.

(51) Int. Cl. A22C 21/00; B05B 14/40

(52) U.S. Cl. CPC A22C 21/0061; A23J 3/00; B05B 14/40

(57) ABSTRACT

A method of processing raw poultry parts to produce a product continuing to qualify as a raw food product, including killing pathogens by increasing the core temperature to a regulatory-required temperature for a regulatory-required duration using mist heated to a temperature not denaturing or deforming the product skin in a manner resulting in a product continuing to have the appearance of a raw delicacy product. Included is an apparatus implementing said method, including a diagonally ascending heating track or chamber substantially filled with a screw auger conveying the poultry parts through the heating process, and a diagonally descending exit chute whereby the heat-processed parts exit the apparatus for final processing for packaging. Also included is a sub-system for recovering and re-using the misting liquids and other liquids exiting the parts, including filtration en route to a reservoir supplying the media for heating for misting the poultry parts.

### CROSS REFERENCE TO RELATED APPLICATIONS

This utility patent application claims the priority benefit of the filing date of U.S. Provisional Application No. 63/540,260 filed 25 Sep. 2023.

### FEDERALLY SPONSORED RESEARCH AND DEVELOPMENT

Not applicable.

### MICROFICHE APPENDIX

Not applicable.

### BACKGROUND OF THE INVENTION

### (1) Field of the Invention

The present invention relates to processing of raw food; more particularly, to processing of raw poultry parts. Even more particularly, the invention disclosed herein has special utility for the processing of raw poultry feet or “paws”, in a manner preserving the appearance of the product and making it suitable for consumption as a delicacy rather than for rendering to be downgraded into the protein constituents.

### (2) Background of the Invention

Especially since the discovery of avian flu in the United States, poultry processing plants have had difficulty economically satisfying regulations governing the processing and export of specific parts (primarily poultry paws), especially the requirements for killing pathogens while maintaining the characterization as a “raw” food product. As a result, the processing of poultry parts such as poultry paws, which formerly had high profit margins based upon their qualification as delicacies in Asian markets, became downgraded so that the parts were suitable only for low-margin uses such as denatured protein. What was once a high-profit product became a low-profit or no-profit product, or even an expense item when considering the cost of disposing of liquids used in and/or produced by such processing.

The monetary difference between protein rendering of poultry paws and exporting them as delicacies to a foreign market is very high. For example, currently the price per pound of the part for protein rendering can be anywhere from 0.08 cents per pound to 0.25 cents per pound. In contrast, the most recent pricing of export paws to China ranged anywhere from $1.90/lb to $2.60/lb. Since it was not uncommon for many poultry processors to ship more than 50,000 pounds of processed paws per week, converting such sales to rendered protein results in major economic loss.

Already known in the field are machines and systems that process poultry and poultry parts. But none of the known machines are capable of processing poultry paws in a manner that expeditiously and efficiently produces pathogen-free paws having the appearance and texture that qualify the product as a delicacy and as a “raw” food product.

Already known in the field is a method and apparatus for pasteurizing raw poultry parts at high temperatures (190° F. up to 212° F.) sufficient to kill pathogens, then immediately cooling at extremely low temperatures (−20° F. to −60° F.). (U.S. Pat. No. 11,234,444 issued to Gunawardena et al.) However, that method and apparatus is materially different than disclosed herein. One primary difference is that Gunawardena's extremely high pasteurization temperature requires the use of extremely low (cryogenic) temperatures to hopefully prevent rendering of the fat in the product and denaturing of its proteins. The system disclosed in this application kills pathogens at much lower temperatures, needs no subsequent cooling, and recovers both the heating-mist liquid and the liquid removed from the poultry, for subsequent filtration and re-use as misting-producing liquid.

Poultry processing requires the collection and disposition of the naturally occurring moisture content in poultry. Meat and poultry are composed of naturally occurring water, muscle, connective tissue, fat, and bone. The muscle is approximately 75% water (although different cuts may have more or less water) and 20% protein, with the remaining 5% representing a combination of fat, carbohydrate, and minerals. The percentage of naturally occurring water in meat varies with the type of muscle, the kind of meat, the season of the year, and the pH of the meat. Fat in meat is found both between muscles and within muscles. A whole broiler-fryer contains 66% water before cooking, and 60% afterwards. (https://www.fsis.usda.gov/food-safety/safe-food-handling-and-preparation/food-safety-basics/water-meat-poultry)

Processing of poultry using high heat and very low chilling, to the extent needed to satisfy the aforementioned regulations, will not produce product both qualifying as “raw” and having the appearance qualifying it as a delicacy. Accordingly, there is a need for an apparatus and method for processing food parts that kills pathogens at much lower temperatures, needs no subsequent cooling, and recovers both the heating-mist liquid and the liquid removed from the food parts, for subsequent filtration and re-use as misting-producing liquid.

### SUMMARY OF THE INVENTION

In most general terms, the invention disclosed herein is a method of processing poultry parts that will produce poultry products that retain their highest value as “delicacies” or as “raw” food products; the invention also includes an apparatus for expeditiously and economically and consistently producing such products. More particularly, the disclosed method and apparatus will produce poultry paws having the appearance of poultry paws considered a delicacy in many Asian markets including the People's Republic of China (“China”), in a manner that satisfies all export and import food safety regulations of the United States and China (concerning killing of pathogens such as Avian Influenza), while retaining the designation as “heat treated” or a “raw” food product, but not fully cooked. (See, https://www.fsis.usda.gov/inspection/import-export/import-export-library/china.) In general, the invention disclosed herein includes (comprises) a method of processing poultry paws including the steps of:
(a) heating a liquid medium to the desired temperature for a misting spray;
(b) depositing separate poultry paws in a screw auger bunching and conveying the paws through a heating chamber wherein each paw is subjected to the misting spray to bring the internal (core) paw temperature to between about 140° F. to about 170° F. (without raising the external temperature to above 210 degrees), for between about 507 continuous seconds (for the low-temperature end of the range) to about 0.5 seconds (for the high-temperature end of the range);
(c) collecting the liquids from the heating chamber and exit chute;
(d) filtering the collected liquids;
(e) producing poultry paws continuing to qualify as “raw” product and with the appearance qualifying as a delicacy product in many Asian markets; and
(f) re-heating the filtered liquids for re-use in the misting spray.

One primary benefit of the disclosed invention (processing method and apparatus) is providing a product continuing to qualify as a “raw” food product in accordance with the USDA's export requirements (See the USDA's Food Safety Inspection Service regulatory guidelines published in January 2023, https://www.fsis.usda.gov/inspection/import-export/import-export-library/china), along with the import requirements imposed by China.

Another primary benefit of the disclosed invention is providing a product having an appearance continuing to qualify as a delicacy poultry paw product in many Asian markets.

Another benefit is providing a process that uses a more sanitary method of heat processing, and an apparatus that is easier to clean.

Another benefit is providing a raw poultry paw delicacy product in a manner that is high-volume, expeditious, consistent and economical.

Another benefit is providing an apparatus requiring minimal space for processing and maintenance/cleaning.

Another benefit is providing an apparatus and process that decreases the dwell time required to heat-process poultry parts, which allows poultry processors to run an inline model that flows with their chicken processing and does not increase production time needed to heat-process certain products.

These and other aspects of the disclosed subject matter, as well as additional novel features, will be apparent from the description provided herein. The intent of this summary is not to be a comprehensive description of the subject matter, but rather to provide a short overview of some of the subject matter's functionality. Other systems, methods, features and advantages herein provided will become apparent to one with skill in the art upon examination of the accompanying figures and detailed description. It is intended that all such additional systems, methods, features and advantages that are included within this description, be within the scope of any claims filed now or later.

In general, the invention disclosed herein heats recently-slaughtered raw chicken parts within a specific core temperature that ranges from a low of about 140° F. to a high of about 170° F. for time periods between about 507 seconds to less than about 1 second. The apparatus is essentially a diagonally inclined screw auger substantially filling a heating chamber or track, for conveying chicken feet (aka “paws”) being sprayed or showered with a misting spray. At or near the top of the heating track, the screw auger ends, and the paws fall down a diagonally declining chute to exit the apparatus, for collection for further processing before packaging.

In the heating track, the apparatus collects or recovers the misting spray liquid and the liquids exiting the paws during the misting spray; essentially the same liquids are also collected below the exit chute. All such liquids are returned to a reservoir to be re-used as misting spray, after the particulates have been filtered out.

Raw chicken parts enter the processor through a collection hopper which feeds the screw conveyor. While conveyance of these parts through the heating chamber is taking place, they receive an application of sprayed heated media. Such media is preferably just water, but it may also include liquids recovered from previous misting spray and/or water treated with additives (such as, but not limited to, antimicrobial additives). In the heating track, the media preferably showers over or mists over the parts as they are conveyed by the screw auger through the heating track. The temperature of this medium can vary up to about 185° F., for achieving the targeted spread of core temperature that ranges from a low of about 140° F. to a high of about 170° F., for time periods between about 507 seconds to about 0.5 seconds. The media is used to raise the internal and external product temperature to a desired or specified temperature. After such heat processing, the parts leave the screw conveyor through a de-watering chute. This de-watering chute continuously captures excess liquid which is then re-used as subsequent misting spray, after filtration.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The novel features believed characteristic of the disclosed subject matter will be set forth in any claims set forth hereinbelow. The disclosed subject matter itself, however, as well as a preferred mode of use, further objectives, and advantages thereof, will best be understood by reference to the following detailed description of an illustrative embodiment when read in conjunction with the accompanying drawings.

FIG. 1 depicts a perspective view of a first side of a representative sample of the processing apparatus, after side panels and maintenance scaffolding have been removed to expose the inner structures.

FIG. 2 depicts a perspective view of a second (opposite) side of the apparatus of FIG. 1. FIG. 3 depicts a top plan view of the apparatus of FIG. 1. FIG. 4 depicts a side elevation cross-section view of the apparatus of FIG. 1, at plane 4-4 of FIG. 3, looking in the direction of the arrows.

FIG. 5 depicts a side elevation view of the apparatus of FIG. 1, with portions of the dual filtration sub-systems shown in cross-section.

FIG. 6 depicts a close-up view of the portion encircled in circle 6 of FIG. 4, depicting the hopper and entrance to the screw auger.

FIG. 7 depicts a close-up view of the portion encircled in circle 7 of FIG. 4.

FIG. 8 depicts a side elevation view of the apparatus of FIG. 2.

FIG. 9 depicts a chute-side elevation view of the apparatus of FIG. 2.

FIG. 10 depicts a close-up view of the dual filtration sub-systems noted in the description of FIG. 5, depicting the dual filtration sub-systems both functional, with all ball valves open.

FIG. 11 depicts the view of FIG. 10, with one filtration sub-system closed.

FIG. 12 depicts the view of FIG. 10, with one sub-system closed and with the other sub-system obstructed from its valves-closed position.

FIG. 13 is a photo of a representative sample of the paws product before entering the apparatus.

FIG. 14 is a photo of a representative sample of the paws product produced by the apparatus and method.

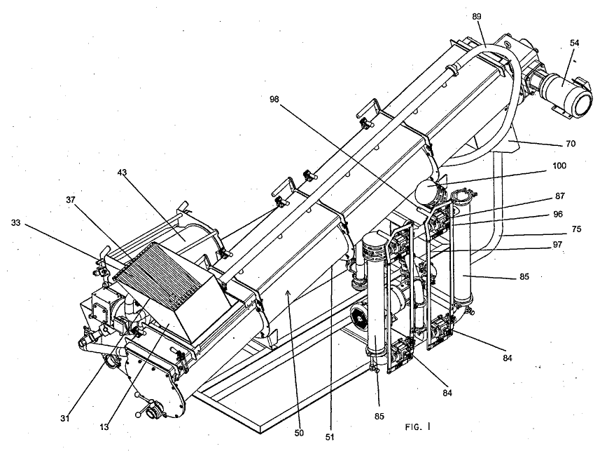

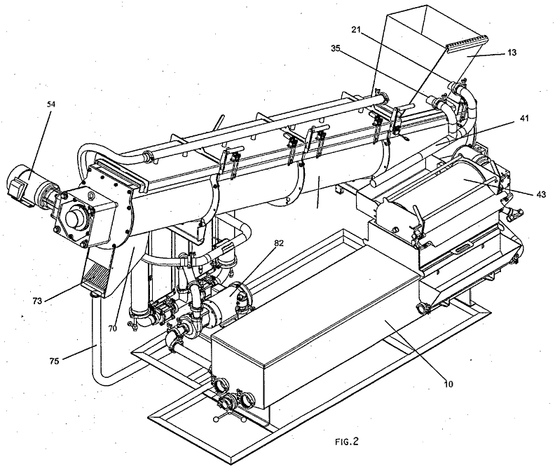

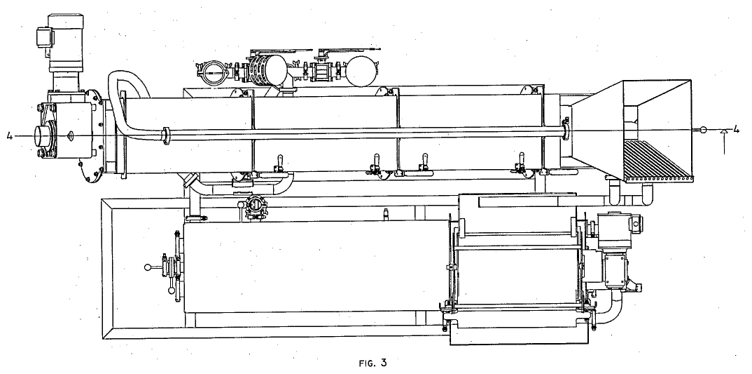

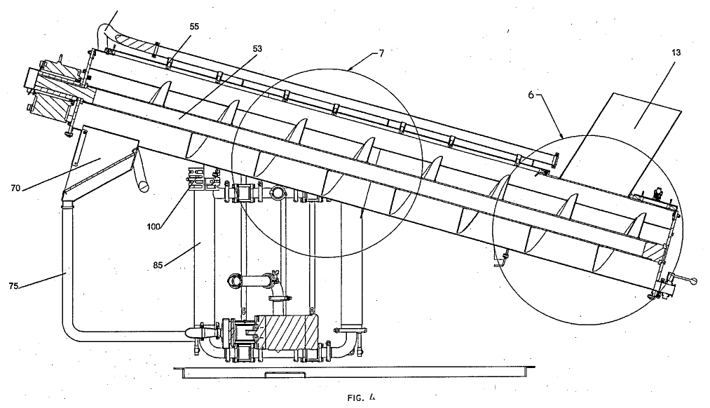

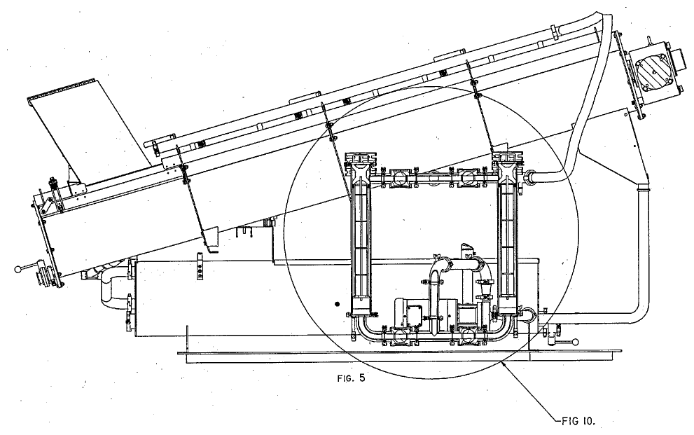

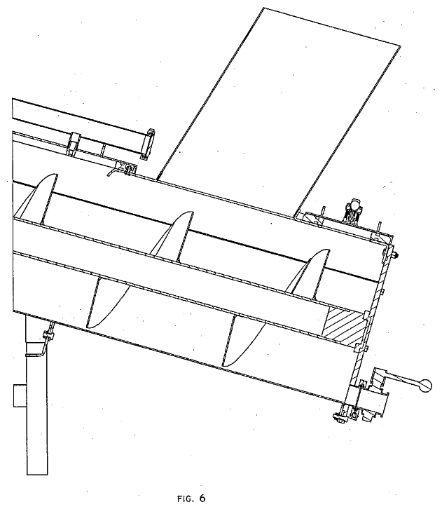

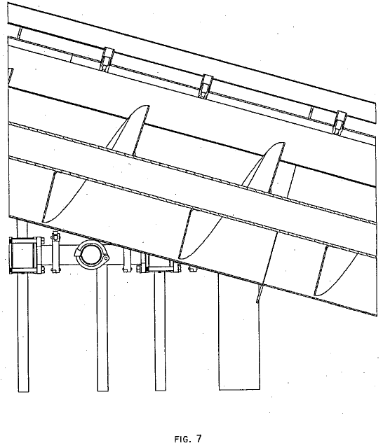

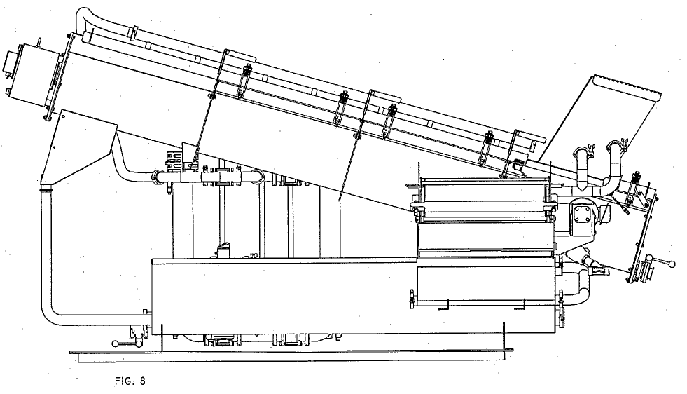

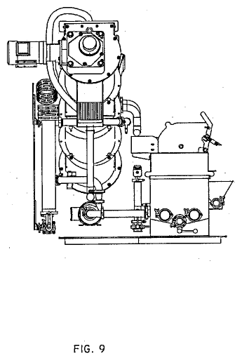

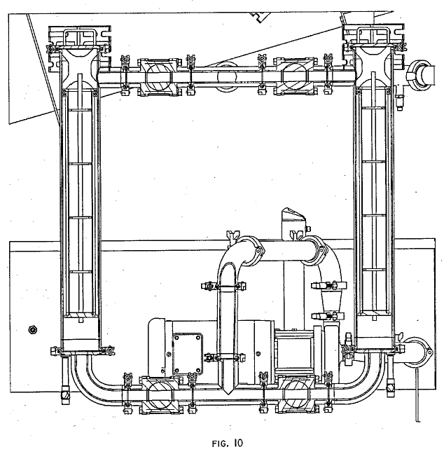

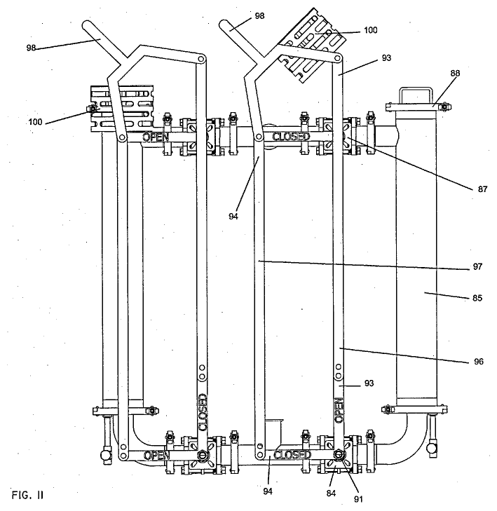

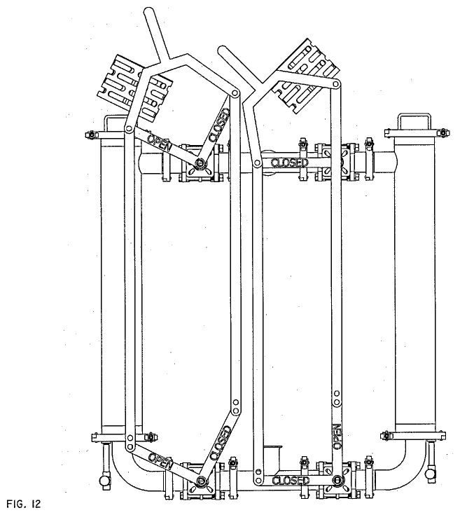

These drawings illustrate certain details of certain embodiments. However, the invention disclosed herein is not limited to only the embodiments so illustrated. The invention disclosed herein may have equally effective or legally equivalent embodiments.

### DETAILED DESCRIPTION OF THE INVENTION

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising”, or “includes” and/or “including”, or “have” or “having”, when used in this specification, specify the presence of stated features, regions, integers, steps, operations, elements and/or components, but do not preclude the presence or addition of one or more other features, regions, integers, steps, operations, elements, components and/or groups thereof.

For the sake of simplicity and to give the claims of this patent application the broadest interpretation and construction possible, the conjunctive “and” may also be taken to include the disjunctive “or,” and vice versa, whenever necessary to give the claims of this patent application the broadest interpretation and construction possible. Likewise, when the plural form is used, it may be taken to include the singular form, and vice versa.

It will be understood that, although the terms first, second, third, etc. may be used herein to describe various elements, these elements should not be limited by these terms. These terms are only used to distinguish one element from another element. Likewise, synonyms for the same element, term or concept may be used only to distinguish one similar element from another, unless the context clearly indicates otherwise.

The disclosure herein is not limited by construction materials to the extent that other materials satisfy the structural and/or functional requirements. For example, any material may be used so long as it satisfies the anti-microbial heating requirements for which it is being used. In one embodiment, the apparatus is constructed of stainless steel material; however, any material in a group of candidate materials sharing at least one function and/or structural feature will suffice as well. Likewise, the disclosed invention is not limited by any construction process or method, unless so indicated.

A device or system that is configured in a certain way is configured in at least that way, but it can also be configured in other ways than those specifically described, so long as the configuration produces the claimed results.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any disclosed device, apparatus, system and/or method can consist of or consist essentially of (rather than comprise/include/have) any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb. Any method including multiple steps is not, but can be, limited to the order of the steps recited in the method.

The feature or features of one embodiment may be applied to or found in other embodiments, even though not described or illustrated, unless expressly prohibited by this disclosure or the nature of the embodiment or feature(s).

The best use of the poultry heat processor is to controllably heat raw chicken parts to achieve a specific targeted internal paw core temperature for a specific duration having regulatory significance for killing pathogens and for continuing to categorize the product as “raw”. This is accomplished by showering the parts for a specific “dwell time” (duration) with media heated to a specific temperature. Ideally, the misting spray will raise the internal core temperature of the paws from about 95° F. to about 149° F. continuously for about 42 seconds. An alternative media temperature/dwell time pairing aims at increasing each paw's internal core temperature to about 158° F. for about 3.5 seconds. Another alternative media temperature/dwell time pairing aims at increasing paw core temperature to about 140° F. for about 507 seconds. A least preferred (but preferred nonetheless) alternative media temperature/dwell time pairing aims at raising paw core temperature to about 165.2° F. for about 0.51 seconds. These targeted core temperatures and durations can be achieved by showering the paws with media heated to the range of between about 150° F. to about 185° F., for a dwell time in the range of between about 300 seconds to about 750 seconds. Achieving any of the targeted core temperatures and durations should satisfy the necessary pathogen kill required by regulations, while maintaining the classification of the product as a “raw” food product, and maintaining its appearance to be characterized as a delicacy.

The dwell time can vary and can be controlled by the length of the heating track, the revolutions per minute of the screw auger (or the motor and gearbox powering it), and through the electrical control panel which utilizes a programmable logic controller and inverter to electronically control the screw conveyor motor.

In preparation for the practice of the method using the apparatus, a bird is hung upside-down along a processing line, with its paws clamped on a shackle line conveyor, then processed until there is nothing left on the shackle line except hanging paws. The shackle line conveyor then drops the paws into the entrance hopper of the diagonally inclined screw auger. In one embodiment, the incline is about 30 degrees upward for about 9 or 10 feet, and the auger has a diameter of about 12 to 14 inches. (However, different degrees of incline and/or length of heating chamber and/or auger dimensions may suffice so long as the resulting paws product has the qualities and characteristics previously described.) The screw auger pushes the paws forward (preferably diagonally upward), and loosely bunches them naturally. This helps assure control of the dwell time, on a first-in first-out basis.

During the ascent, the paws are showered with hot misting spray. For the preferred media temperature/dwell time for achieving a 149° F. core temperature continuously for about 42 seconds, the misting spray is about 180° F., coming from about 8 nozzles spaced along 9-10 ft. auger track, for a dwell time of about 70 seconds. It is noteworthy that the misting spray does not degrade the paws appearance or denature the protein like full emersion in hot water of the same temperature and duration. The misting spray condenses and drips downwardly into a trough underlying the heating track, then is filtered en route to the reservoir to remove particulate matter. During the first filtration, the collected liquid cascades through a screen filter or weir filter to remove the larger solid particulates. For removal of smaller particles before being sprayed as heated misting spray, the liquid is pumped through a pressure filtration system to apply reverse osmosis; the reclaimed liquids are pumped through a semi-permeable membrane filter within a cylinder, to remove the remaining smaller particles. The system may include a plurality of such reverse osmosis filter systems.

After being showered with hot misting spray in the heating track, the paws fall down a diagonally declining chute having a floor comprising closely-spaced parallel bars forming a grate. There is a catch-plate underlying that chute grate, collecting additional liquids from the paws on the journey to the paws exit. The liquids are funneled into a collection pipeline for return to the first filtration sub-system en route to the heating reservoir.

The apparatus recycles and recirculates all liquids used and produced by the apparatus during operation. Typically, the apparatus supplies heated media to the nozzles at the rate of between about 75 gallons per minute to about 170 gallons per minute; in one preferred embodiment, about 8 or 9 nozzles each disburse misting spray at the rate of about 15 gallons per minute. Typically, the filtration and heating capacities of the apparatus for recycling liquids at least matches the aggregate rate of nozzle disbursement of misting spray; ideally the processing capacities of the apparatus at least match those of the remainder of the chicken processing line in the plant. If more media is needed to assure such matching of capacities, the heating reservoir may be supplied with an auxiliary supply of media; sensors in the reservoir may cause the auxiliary supply to re-supply the reservoir with the needed volume of media. To guard against oversupply of media in the apparatus at any time, the reservoir and the hopper each have an overflow drain or exit accepting excess media.

The misting spray showered on the paws in the heating chamber, and the liquids emitted from the paws in the heating chamber, are collected by the floor of the heating chamber and gravity fed down to the hopper and into a reclamation drain for a pipeline supplying liquid to a screen filter, to remove larger particles. That filtered flow of liquid is carried by a pipeline to the heating reservoir. The reservoir media includes that filtered liquid plus liquid collected from the de-watering chute, plus any fluid added from the source if needed. After reaching the appropriate temperature, that combined media is then pumped under pressure into one of two reverse osmosis filtration sub-systems, for removal of smaller particles. This second filtration occurs immediately before the heated media is routed by another pipeline to the nozzles in the head space of the heating chamber, as misting spray.

The dual pressure-pump filtration system is engineered to allow easy cleaning of the filters while the apparatus is operating, and to prevent injury to the operators and to the pumps. Either of the two filtration sub-systems can be taken off line and cleaned while the other is in use, but nobody can access the internal filter of either sub-system while its pump is working. And the mechanics of the lever linkages for both sub-systems physically prevent both sub-systems from being taken off line concurrently while the pumps are working without any fluid to pump. This also insures that no filter is able to be opened while the pump is running.

Each pressure filter cylinder has a ball valve at its entrance and at its exit, that ideally should be opened and closed simultaneously. Such synchronized opening and closing of the upper and lower ball valves of each pressure filter cylinder is accomplished by a pivot rod extending out of the casing of each respective ball valve, which may be mechanically or manually rotated for opening and closing that valve. Each pivot rod also provides a pivot point at the juncture of two pivot arms that are joined essentially perpendicularly to each other in a V-like orientation. The free end of each pivot arm is mechanically linked by a respective strut to the free end of the complimentary pivot arm on the pivot rod of the other ball valve. The mechanical assembly of struts linking the pivot rods of both upper and lower ball valves may also include a lever or similar handle for opening or closing both valves simultaneously. One of the pivot arms on the pivot point of the upper ball valve also carries an attached cage which obstructs manual access for removal of the clean-out cap of the pump cylinder while that pump is operational; this prevents injury to personnel. When the lever is moved to close the upper and lower ball valves simultaneously (signaling that the pump is not operational), the upper pivot arm lifts the cage to allow manual access to the clean-out cap at a time when there is no hot liquid being pumped or filtered.

There is an additional safety feature of the system disclosed herein, to protect the filter pumps. The two pressure-pump sub-systems are situated side by side, each including a vertical cylinder having a lower inflow fitting having a ball valve regulating pressurized entry of heated media and having an upper outflow fitting having a ball valve regulating pressurized exit of heated media for routing to the nozzles. The top of each cylinder has a closure cap, which must be removed when a filter needs to be cleaned or replaced. Although the apparatus only needs one of the sub-systems functioning during operation, each respective sub-system needs to have both lower and upper ball valves open when in use. The apparatus may function with both pressure filters operational. The apparatus may not function with no pressure filter operational. When the apparatus is functioning with both pressure filters operational, one of the pressure filters can be taken offline by moving the lever to close the upper and lower ball valves of that filter cylinder; the cage will be lifted away from the cylinder cap, so that the filter may be cleaned or replaced. Given the space constraints of the mechanical linkages for both pressure filters, it is impossible to make both filters non-operational because the linkages for at least one of the pressure filters must always be in the operational configuration. This prevents burn-out of the pump, by operating without liquid supply. This feature is also for the safety of operators and sanitation personnel. The closed cap makes it impossible to open the pressure filter device while hot media is being pumped through the pressure filter, thereby eliminating the risk of hot water exposure from the pressure filters to any personnel.

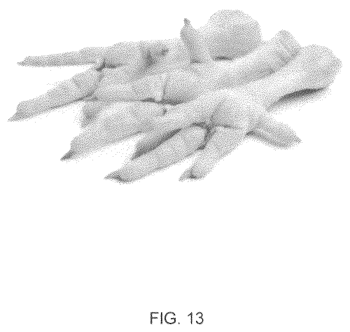

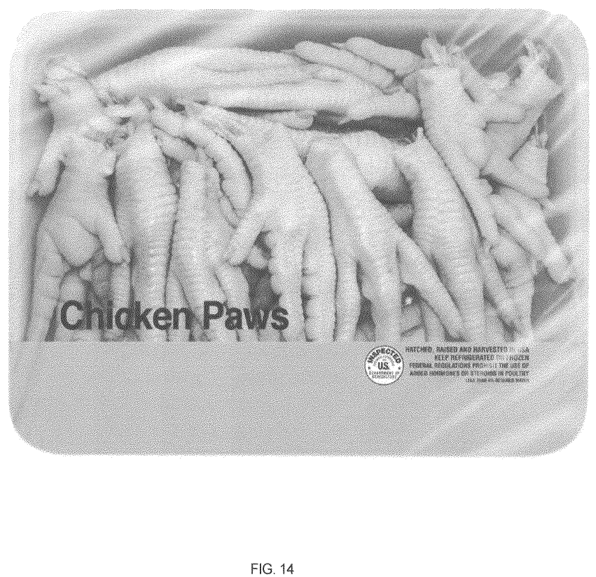

FIG. 11 shows the apparatus in use with both pressure-pump filtration sub-systems functional, both having its respective lower ball valve and upper ball valve open. FIG. 12 shows the apparatus in use with only one pressure-pump filtration sub-system functional while the other system is off line with its lower and upper ball valves closed (and with its closure cap exposed for rotational removal). FIG. 13 shows the configuration of the lever linkages when there is an attempt to take both sub-systems off line, showing that there is not enough space between the two pump systems to allow both levers to be moved to the “closed” position at the same time.

With the preferred temperature/time target pairing, the apparatus using the method can process/produce 280-350 paws per minute.

The apparatus disclosed herein is generally described as an apparatus for heat processing protein parts while maintaining their classification as raw food, including an entrance (31) accepting the parts for deposit onto a conveyor means (53) for conveying the parts. The entrance leads to a heating chamber (50) housing the conveyor means and including a plurality of nozzles (55) spaced apart for showering heated spray media upon the parts during conveyance to an exit end. The apparatus includes a first liquid collection structure underlying the conveyor means and routing first-collected liquid into a reclamation drain (35) routing the first-collected liquid into a first filtering means (43) filtering particulate matter from the first-collected liquid before routing it to a heating reservoir (10). The apparatus also includes a dewatering chute (70) descending from the heating chamber exit end and including a second liquid collection structure routing second-collected liquid into a heating reservoir (10) for storing and heating liquid as heated spray media; also included is a fluid pathway between the reservoir and the nozzles, together with a pump (82) supplying heated spray media under pressure to the nozzles.

Ideally the apparatus further comprises an auxiliary filtering means filtering the heated spray media being pumped to the nozzles. Preferably the auxiliary filtering means include a reverse osmosis membrane filter system including an inflow entrance and an outflow exit. Preferably the membrane filter system includes an encasement (85) enclosing a semipermeable membrane filter and accepting the pumped heated spray media through an inflow valve (84) and discharging the media through an outflow valve (85); it may further include a synchronized actuation means for simultaneously opening and closing the inflow and outflow valves, each valve typically being encased in a casing and having a pivot rod (91) actuating the opening and closing of the respective ball valve and extending out of the casing.

Preferably the synchronized actuation means includes:
(a) for each of the inflow and outflow ball valves, a respective pivot arm having a 1st end (93) and an opposite 2nd end (94) and an intermediate pivot point affixed to the respective pivot rod, both 1st ends of the pivot arms of the inflow and outflow ball valves being aligned in cooperating relationship with each other and both 2nd ends of the pivot arms being aligned in cooperating relationship with each other; and
(b) a 1st strut (96) linking both 1st ends, and a 2nd strut (97) linking both 2nd ends; and
(c) a leverage point (98) whereby movement of the leverage point simultaneously rotates the pivot rods of both the inflow and outflow ball valves to open or close the ball valves simultaneously.

Preferably the encasement enclosing the semipermeable membrane further includes a removable cap (88) providing access to the semipermeable membrane; the synchronized actuation means further includes a cage-like obstructor attached thereto and configured to obstruct access to the cap when the synchronized actuation means is moved to its valves-open position, and configured to enable access to the cap when the synchronized actuation means is moved to its valves-closed position.

Ideally the apparatus includes at least two auxiliary filtering means and synchronized actuation means, allowing one filter to be cleaned or serviced while the other is operating. Each respective synchronized actuation means maybe configured to actuate simultaneous opening of the respective inflow and outflow ball valves but, when in its valves-closed position, is configured to obstruct the synchronized actuation means of an adjacent auxiliary filtering means from moving into its respective valves-closed position.

For each respective auxiliary filtering means, the encasement enclosing the semipermeable membrane may further include a removable cap providing access to the semipermeable membrane. The respective synchronized actuation means may further include an obstructor attached thereto and configured to obstruct access to the cap when the synchronized actuation means is moved to its valves-open position, and configured to enable access to the cap when the synchronized actuation means is moved to its valves-closed position.

In a more specific embodiment, the apparatus for heat processing protein parts while maintaining their classification as raw food, may include:
(a) an entrance (31) accepting the parts for deposit onto an auger conveyor (53) for conveying the parts;
(b) a heating chamber (50) housing the conveyor means and including a plurality of nozzles (55) spaced apart for showering heated spray media upon the parts during conveyance to an exit end, and having a liquid collection trough underlying the conveyor and routing collected heating chamber liquid into a reclamation drain (35) routing the heating chamber liquid into a drum filter (43) filtering particulate matter from the heating chamber liquid before routing it to a heating reservoir (10);
(c) a dewatering chute (70) descending from the heating chamber exit end and including a liquid collection catch-plate routing dewatering chute collected liquid into the heating reservoir (10) for storing and heating liquid as heated spray media; and
(d) a fluid pathway between the reservoir and the nozzles, and including a pump (82) supplying heated spray media under pressure to an auxiliary filtering means supplying the heated spray media under pressure to the nozzles.

The auxiliary filtering means may include a first and a second reverse osmosis membrane filter, each including an inflow entrance and an outflow exit and including an encasement (85) enclosing a semipermeable membrane filter accepting pumped heated spray media through an inflow valve and discharging the media through an outflow valve. Each respective first and second synchronized actuation means may be configured to actuate simultaneous opening of the respective inflow and outflow ball valves but, when in its valves-closed position, is configured to obstruct the synchronized actuation means of the other auxiliary filtering means from moving into its respective valves-closed position. For example, when the first synchronized actuation means of the first auxiliary filtering means is in its valves-closed position, one of its 1st or 2nd struts occupies space preventing the second synchronized actuation means of the second auxiliary filtering means from moving into its respective valves-closed position.

In one embodiment of the apparatus, the heating chamber may include a housing defining the chamber having a lumen about 12 to 14 inches in cross-section, and a length of about 8 feet to about 10 feet long, and diagonally inclining at an angle of about 15 degrees to about 85 degrees, supporting about 8 to about 10 nozzles each showering media at the rate of about 10 gallons per minute to about 20 gallons per minute. The media should be heated to the range of about 150° F. to about 185° F. More specifically, the heating chamber may include a housing having a length of about 9 feet and diagonally inclining at an angle of about 30 degrees, supporting about 8 nozzles each showering media at the rate of about 15 gallons per minute, heated to about 180° F.; the auger conveyor preferably should rotate at a rate conveying the parts through the showering for about 70 seconds, resulting in each part maintaining an internal core temperature of about 149° F. for about 42 seconds. Alternatively, the media should be heated to about 185° F.; and the auger conveyor should be rotating at a rate conveying the parts through the showering for about 45 seconds, resulting in each part maintaining an internal core temperature of about 158° F. for about 3.5 seconds.

Besides the apparatus disclosed herein, the invention includes a method of processing protein parts in the apparatus disclosed herein, including the steps of:
(a) feeding the protein parts serially to the entrance of the heating chamber, for uptake by the conveyor means and transport through the heating chamber; and
(b) showering the parts with media heated to the range of between about 150° F. to about 185° F., for a dwell time in the range of between about 750 seconds to about 300 seconds.

In one exemplary embodiment of the processing method, the internal core temperature of each part should be increased to about 149° F. for about 42 seconds before subsiding. Alternatively, the internal core temperature of each part should be increased to about 158° F. for about 3.5 seconds before subsiding.

The method may further including the steps of collecting the first-collected liquid and filtering it before routing it to the heating reservoir and/or collecting the second-collected liquid and routing it to the heating reservoir, then pumping the heated spray media through an auxiliary filtering means en route to the nozzles.

Although the present disclosure and its advantages have been described in detail, it should be understood that various changes, substitutions and alterations can be made herein without departing from the spirit and scope of the design as defined by the appended claims. The scope of the present application is not intended to be limited to the particular embodiments of the process, machine, manufacture, composition of matter, means, methods and/or steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. The scope of the present application is not intended to be limited to the particular embodiments of the process, machine, manufacture, composition of matter, means, methods and steps described in the specification.

While a preferred embodiment of the present invention has been described, it should be understood that various changes, adaptations and modifications may be made therein without departing from the spirit of the invention. Changes may be made in details, particularly in matters of shape, size, material, and arrangement of parts without exceeding the scope of the invention.

While the forms of apparatus herein described constitute preferred embodiments of the invention, it is to be understood that the invention is not limited to these precise forms of apparatus, and that changes may be made therein without departing from the scope and spirit of the invention as defined in the appended claims.

Those skilled in the art will recognize improvements and modification to the preferred embodiments of the present disclosure. All such improvements and modifications are considered within the scope of the concepts disclosed herein and the claims that follow.

1. An apparatus for heat processing protein parts while maintaining their classification as raw food, comprising:
(a) an entrance accepting the parts for deposit onto a conveyor means for conveying the parts;
(b) a heating chamber housing said conveyor means and comprising a plurality of nozzles spaced apart for showering heated spray media upon the parts during conveyance to an exit end, and having a first liquid collection structure underlying said conveyor means and routing first-collected liquid into a reclamation drain routing said first-collected liquid into a first filtering means filtering particulate matter from the first-collected liquid before routing it to a heating reservoir;
(c) a dewatering chute descending from said heating chamber exit end and comprising a second liquid collection structure routing second-collected liquid into a heating reservoir for storing and heating liquid as heated spray media; and
(d) a fluid pathway between said reservoir and said nozzles, and comprising a pump supplying heated spray media under pressure to said nozzles.

2. The apparatus of claim 1 above, wherein said fluid pathway further comprises an auxiliary filtering means filtering the heated spray media being pumped to said nozzles.

3. The apparatus of claim 2 above, said auxiliary filtering means comprising a reverse osmosis membrane filter system comprising an inflow entrance and an outflow exit.

4. The apparatus of claim 3, said membrane filter system comprising an encasement (85) enclosing a semipermeable membrane filter and accepting the pumped heated spray media through an inflow valve and discharging said media through an outflow valve, and further comprising a synchronized actuation means for simultaneously opening and closing said inflow and outflow valves.

5. The apparatus of claim 4, said valves comprising an inflow ball valve and an outflow ball valve, each encased in a casing and having a pivot rod actuating the opening and closing of the respective ball valve and extending out of said casing, said synchronized actuation means comprising:
(a) for each of said inflow and outflow ball valves, a respective pivot arm having a 1^{st} end and an opposite 2^{nd} end and an intermediate pivot point affixed to the respective pivot rod, both 1^{st} ends of said pivot arms of said inflow and outflow ball valves aligned in cooperating relationship with each other and both 2^{nd} ends of said pivot arms aligned in cooperating relationship with each other; and
(b) a 1^{st} strut linking both 1^{st} ends, and a 2^{nd} strut linking both 2^{nd} ends; and
(c) a leverage point whereby movement of the leverage point simultaneously rotates the pivot rods of both the inflow and outflow ball valves to open or close said ball valves simultaneously.

6. The apparatus of claim 5, said encasement enclosing said semipermeable membrane further comprising a removable cap providing access to said semipermeable membrane, said synchronized actuation means further comprising an obstructor attached thereto and configured to obstruct access to said cap when said synchronized actuation means is moved to its valves-open position, and configured to enable access to said cap when said synchronized actuation means is moved to its valves-closed position.

7. The apparatus of claim 2 above, wherein said fluid pathway further comprises a plurality of said auxiliary filtering means.

8. The apparatus of claim 6, wherein said fluid pathway further comprises a plurality of auxiliary filtering means, each comprising a respective synchronized actuation means configured to actuate simultaneous opening of the respective inflow and outflow ball valves but, when in its valves-closed position, is configured to obstruct the synchronized actuation means of an adjacent auxiliary filtering means from moving into its respective valves-closed position.

9. The apparatus of claim 8 wherein, for each respective auxiliary filtering means, said encasement enclosing said semipermeable membrane further comprising a removable cap providing access to said semipermeable membrane, said respective synchronized actuation means further comprising an obstructor attached thereto and configured to obstruct access to said cap when said synchronized actuation means is moved to its valves-open position, and configured to enable access to said cap when said synchronized actuation means is moved to its valves-closed position.

10. An apparatus for heat processing protein parts while maintaining their classification as raw food, comprising:
(a) an entrance accepting the parts for deposit onto an auger conveyor for conveying the parts;
(b) a heating chamber housing said conveyor means and comprising a plurality of nozzles spaced apart for showering heated spray media upon the parts during conveyance to an exit end, and having a liquid collection trough underlying said conveyor and routing collected heating chamber liquid into a reclamation drain routing said heating chamber liquid into a drum filter filtering particulate matter from the heating chamber liquid before routing it to a heating reservoir;
(c) a dewatering chute descending from said heating chamber exit end and comprising a liquid collection catch-plate routing dewatering chute collected liquid into said heating reservoir for storing and heating liquid as heated spray media; and
(d) a fluid pathway between said reservoir and said nozzles, and comprising a pump supplying heated spray media under pressure to an auxiliary filtering means supplying said heated spray media under pressure to said nozzles.

11. The apparatus of claim 10 above, said auxiliary filtering means comprising a reverse osmosis membrane filter system comprising an inflow entrance and an outflow exit and including an encasement enclosing a semipermeable membrane filter and accepting pumped heated spray media through an inflow valve and discharging said media through an outflow valve, and further comprising an inflow ball valve and an outflow ball valve, each comprising a casing enclosing a ball valve including a pivot rod opening and closing said respective ball valve and extending out of said casing, said auxiliary filtering means further comprising a synchronized actuation means for simultaneously opening and closing said inflow and outflow valves and comprising:
(a) for each of said inflow and outflow ball valves, a respective pivot arm having a 1st end and an opposite 2nd end and an intermediate pivot point affixed to the respective pivot rod, both 1st ends of said pivot arms of said inflow and outflow ball valves aligned in cooperating relationship with each other and both 2nd ends of said pivot arms aligned in cooperating relationship with each other; and
(b) a 1st strut linking both 1st ends, and a 2nd strut linking both 2nd ends; and
(c) a leverage point whereby movement of the leverage point simultaneously rotates the pivot rods of both the inflow and outflow ball valves to open or close said ball valves simultaneously.

12. The apparatus of claim 11, said encasement enclosing said semipermeable membrane further comprising a removable cap providing access to said semipermeable membrane, said synchronized actuation means further comprising an obstructor attached thereto and configured to obstruct access to said cap when said synchronized actuation means is moved to its valves-open position, and configured to enable access to said cap when said synchronized actuation means is moved to its valves-closed position.

13. The apparatus of claim 12, wherein said fluid pathway further comprises said auxiliary filtering means comprising a first auxiliary filtering means and a second auxiliary filtering means, each comprising a respective synchronized actuation means configured to actuate simultaneous opening of the respective inflow and outflow ball valves but, when in its valves-closed position, is configured to obstruct the synchronized actuation means of the other auxiliary filtering means from moving into its respective valves-closed position.

14. The apparatus of claim 13 wherein, when said synchronized actuation means of said first auxiliary filtering means is in its valves-closed position, one of its 1^{st} or 2^{nd} struts occupies space preventing the synchronized actuation means of the second auxiliary filtering means from moving into its respective valves-closed position.

15. The apparatus of claim 10 above, said heating chamber further comprising a housing defining said chamber having a lumen about 12 to 14 inches in cross-section, and a length of about 8 feet to about 10 feet long and diagonally inclining at an angle of about 15 degrees to about 85 degrees, supporting about 8 to about 10 nozzles each showering media at the rate of about 10 gallons per minute to about 20 gallons per minute, said media heated to the range of about 150° F. to about 185° F.

16. The apparatus of claim 15 above, said heating chamber comprising a housing having a length of about 9 feet and diagonally inclining at an angle of about 30 degrees, supporting about 8 nozzles each showering media at the rate of about 15 gallons per minute, heated to about 180° F., said auger rotating at a rate conveying the parts through said showering for about 70 seconds, resulting in each part maintaining an internal core temperature of about 149° F. for about 42 seconds.

17. The apparatus of claim 15 above, said heating chamber comprising a housing having a length of about 9 feet and diagonally inclining at an angle of about 30 degrees, supporting about 8 nozzles each showering media at the rate of about 15 gallons per minute, heated to about 185° F., said auger rotating at a rate conveying the parts through said showering for about 45 seconds, resulting in each part maintaining an internal core temperature of about 158° F. for about 3.5 seconds.

18. A method of processing protein parts in the apparatus of claim 1, comprising the steps of:
(a) feeding the protein parts serially to the entrance of the heating chamber, for uptake by the conveyor means and transport through the heating chamber; and
(b) showering the parts with media heated to the range of between about 150° F. to about 185° F., for a dwell time in the range of between about 750 seconds to about 300 seconds.

19. The method of claim 18, said internal core temperature of each part increased to about 149° F. for about 42 seconds before subsiding.

20. The method of claim 18, said internal core temperature of each part increased to about 158° F. for about 3.5 seconds before subsiding.

21. The method of claim 18, further comprising the steps of collecting said first-collected liquid and filtering it before routing it to said heating reservoir.

22. The method of claim 21, further comprising the step of collecting said second-collected liquid and routing it to the heating reservoir, then pumping said heated spray media through an auxiliary filtering means en route to said nozzles.
